(19) United States
(12) Patent Application Publication
(10) Pub. No.: US 2007/0180257 A1
(43) Pub. Date: Aug. 2, 2007

(54) Application-based access control system and method using virtual disk

(76) Inventors: Steve Bae, Seoul (KR); Do-Gyun Kim, Yangpyeong-Gun (KR); Aiden Kang, Seoul (KR); Hee-Gook Lee, Bucheon-si (KR); Jong-Deok Baek, Gunpo-si (KR); Yang-Jin Seo, Seoul (KR)

Correspondence Address: IPLA P.A., 3580 WILSHIRE BLVD., 17TH FLOOR, LOS ANGELES, CA, 90010, US

(21) Appl. No.: 10/598,218

(22) PCT Filed: Feb. 4, 2005
(86) PCT No.: PCT/KR05/00345

§ 371 Date: Aug. 21, 2006

(30) Foreign Application Priority Data
Feb. 24, 2004 (KR) 10-2004-0012380

(51) Int. Cl. G06F 21/06

(52) U.S. Cl. 713/182

(57) ABSTRACT

An application-based access control system is disclosed. The access control system includes a Virtual space of a hard disk in a file form; a VSD drive for processing security-sensitive access control module 50 files within the VSD image file module; an encryption and decryption module for encrypting and decrypting data input/output between the VSD image file module and the VSD drive; a VSD file system module for allowing an operating system to recognize a separate disk volume at a time of access to the security-sensitive files within the VSD image file module; and an access control module for determining access by determining whether an access location is a disk drive or the VSD drive and the application module has been authorized to access a certain file at a time of access to the file, which is stored on the hard disk, to perform tasks in the application module. Secure Disk (VSD) image file module occupying a certain

[symbol]

### TECHNICAL FIELD

The present invention relates to an access control system that is configured to prevent data (files containing program source code or design drawings), which are integrally managed on a local area network or a shared personal computer, from being leaked out by internally authorized persons, and to block access by external persons.

### BACKGROUND ART

Companies or public institutions operate firewalls to block access by persons who do not meet certain requirements or to prevent the intrusion into data at the time of connection with an external network so as to prevent the illegal leakage of information through unauthorized access from the outside and protect important internal secret and internal information. Such a firewall is a solution for simply blocking external intrusion over a network, or detecting and reacting to external intrusion if the firewall is defeated by the external intrusion. Firewalls are classified into a firewall based on a passive defense concept, such as an Intrusion Detection system (IDS) that previously stores descriptions of various hacking techniques and, thus, can detect and control intrusions in real time, and a firewall based on an aggressive concept, such as an Intrusion Prevention System (IPS) that is based on a concept in which an intelligence function and an active function of positively and automatically reacting to intrusions are combined with each other, and that monitors whether suspicious activities are being conducted in equipment that is connected to a network by searching for attack signatures and interrupts the activities by taking certain measures. However, such firewalls are only applications to prevent external intruders from accessing a Local Area Network (LAN) or a Personal Computer (PC), and are not capable of preventing the case in which internally authorized persons leak out the information.

Accordingly, in order to prevent the exposure of companies' or public institutions' important information to the public by internally authorized persons and the illegal leakage of the information, a security system that is conceptually different from such a firewall is demanded.

To meet the demand, conventionally, only a person who has the authority to use a PC is allowed to use the PC by continuing to perform a booting process through a password input using password authentication process that is performed by a Basic Input/Output System (BIOS) before an Operating System (OS) booting process, or a Data Base (DB) determines whether a client PC gains access by determining whether the client PC, which requests access to the DB, has been authorized to access to a DB while grouping and separately managing the security-sensitive data at the time of access to a main server via a LAN.

In addition, only persons who have proper authority are allowed to access a DB in which security-sensitive data are stored or to use a PC using a separate biometric apparatus using biometrics, such as fingerprint or iris recognition.

However, the above-described prior art related to internally authorized remains defenseless with regard to data leakage because the authorized persons may use the DBs and PCs to leak out security-sensitive data themselves. Furthermore, as technology is becoming complicated, subdivided and specialized, access to and editing of shared data by a plurality of authorized persons who are working on a single technology are required, so that all internally authorized persons are allowed to access a DB in which shared data are stored without limitation on access to the DB, or security-sensitive data and general data can be integrally managed in a single DB.

Accordingly, in addition to a demand for a technique that prevents data leakage by internally authorized persons, a control system and method that allow access to and editing of data that are integrally managed in a DB or a hard disk are facilitated without the addition of separate high priced equipment, such as a biometric recognition apparatus, or the use of a complicated checking process, such as password input and user authentication.

Meanwhile, in the case of encrypting existing security-sensitive documents or granting authority to use the files, for programs that create a plurality of extensions and temporary files based on file name extensions, such as a Computer Aided Design (CAD) program or a program compiler, the prior art is disadvantageous in that it is difficult to encrypt the corresponding files or grant authority to use the corresponding files.

### DISCLOSURE

### Technical Problem

Accordingly, the present invention has been made keeping in mind the above problems occurring in the prior art, and an object of the present invention is to provide an application-based access control system and method using a virtual disk, in which, for security-sensitive data and general data integrally managed using a single DB at a LAN level or data integrally managed on a hard disk without previously physically partitioning the hard disk at a PC level, access to and editing of the security-sensitive data can be freely performed without requiring a separate password input or authentication process by internally authorized persons, and the leakage of data by internally authorized persons as well as external intruders is blocked, so that leakage by internal persons is prevented while not interfering with access to data or tasks that require such access.

### TECHNICAL SOLUTION

In order to accomplish the above object, the present invention provides an access control system, including a VSD image file module occupying a certain space of a hard disk in a file form; a VSD drive for processing security-sensitive files within the VSD image file module; an encryption and decryption module for encrypting and decrypting data input/output between the VSD image file module and the VSD drive; a VSD file system module for allowing an operating system to recognize the VSD drive as a separate disk volume at a time of access to the security-sensitive files within the VSD image file module; and an access control module for determining access by determining whether an access location is a disk drive or the VSD drive and the application module has been authorized to access a certain file at a time of access to the file, which is stored on the hard disk, to perform tasks in the application module.

In addition, the present invention provides an access control method, which is performed by an access control system having a hard disk, a disk drive, a file system module, an application module, a VSD image file module, a VSD drive, an encrypting/decrypting module, a VSD file system module, and a control access module including an extended system service table and an extended service table, including (a) the step of authorizing the application modules; (b) the step of the application module calling a function from an operating system to access a corresponding file; (c) the step of the operating system providing the function to the extended service table; (d) the step of changing the function into an arbitrarily designated function to prevent the operation of the function in the extended service table; (e) the step of determining whether the access space of the file is the disk drive or the VSD drive in the extended service table; (f) the step of returning the arbitrarily designated function to the original function whose operation is possible, and providing the original file to the extended system service table if it is determined that the access space is the disk drive at step (e); (g) the step of determining whether access to the application module has been authorized if it is determined that the access space is the disk drive at step (e); (h) the step of returning the arbitrarily designated function to the original function whose operation is possible, and providing the original function to the extended system service table if it is determined that the application module has been authorized at step (g); and (i) the step of stopping the operation of the corresponding function if it is determined that the application module has not been authorized at step (g).

### DESCRIPTION OF DRAWINGS

FIG. 1 is a block diagram illustrating the operation of an access control system according to the present invention;

FIG. 2 is a block diagram showing the construction of the access control system according to an embodiment of the present invention;

FIG. 3 is a block diagram illustrating a process of setting up a virtual disk of the access control system according to the present invention;

FIG. 4 is a block diagram illustrating the operation of a conventional system service table;

FIG. 5 is a block diagram illustrating the operation of a system service table applied to the access control system according to the present invention;

FIG. 6 is an example illustrating a process in which whether access to a corresponding file has been authorized by an application program (an application module) is processed according to the construction of FIG. 5;

FIG. 7 is a flowchart illustrating a process of reading a file by an application program in the access control system according to the present invention;

FIG. 8 is a flowchart illustrating a process of writing a corresponding file by an application program in the access control system according to the present invention;

FIG. 9 is my computer window showing the state before the access control system according to the present invention is installed;

FIG. 10 is ‘my computer’ window showing the state after the access control system according to the present invention has been installed;

FIG. 11 is a window showing that the virtual disk of the access control system according to the present invention is recognized as a file; and

FIG. 12 is a window showing that an access attempt by an unauthorized application module is refused at the time of access to the virtual disk.

### BEST MODE

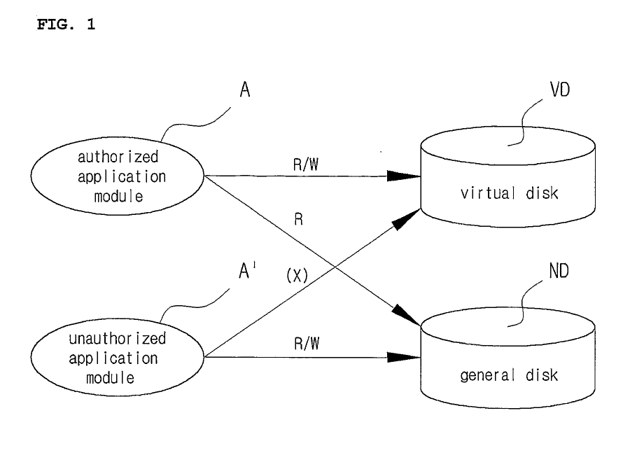

FIG. 1 is a block diagram illustrating the operation of an access control system according to the present invention. The following description is made with reference to the drawing.

The access control system according to the present invention allows Read and Edit of security-sensitive files to be freely performed using an authorized application module A, which can process the files (in this case, operations of performing tasks, such as Read and/or Write from and to files) without an additional process, such as password input or authentication, at the time of access by internally authorized persons.

Meanwhile, access processes using an authorized application module A and an unauthorized application module A′ are distinguished from each other by generating a virtual disk VD without the physical partition of a hard disk (the hard disk is called a DataBase (DB) at the level of a server, but is used as a higher concept, including a DB as well as the hard disk of a general PC). The concept of the virtual disk VD is described in more detail below.

That is, as shown in FIG. 1, the authorized application module A can access the virtual disk VD in which only files requiring security (hereinafter referred to as “security-sensitive files”) are stored, and perform Read and Write R/W on the security-sensitive files. In contrast, the unauthorized module A′ cannot perform Read and Write on the security-sensitive files (X), but can perform Read and Write on files stored on a general disk ND other than the virtual disk VD.

Meanwhile, the authorized application module A can perform Read on the files stored on the general disk ND, but cannot perform Write on the files. The reason for this is to prevent the security-sensitive files from being transferred to the general disk ND and then stored thereon after updating the security-sensitive files stored on the virtual disk VD (that is, storing the security-sensitive files using new names).

In the relationship between the authorized application module A/the unauthorized application module A′ and the virtual disk VD/the general disk ND that is constructed as shown in FIG. 1, the types of the processing of files is not limited to those shown in FIG. 1, but may vary in various ways.

In that case, the term VSD is the abbreviation of a virtual secure disk, and refers to a virtual disk that is used to store security-sensitive files in the present invention. The term VSD will be used to distinguish the virtual disk from a conventional hard disk, a disk drive and a file system module.

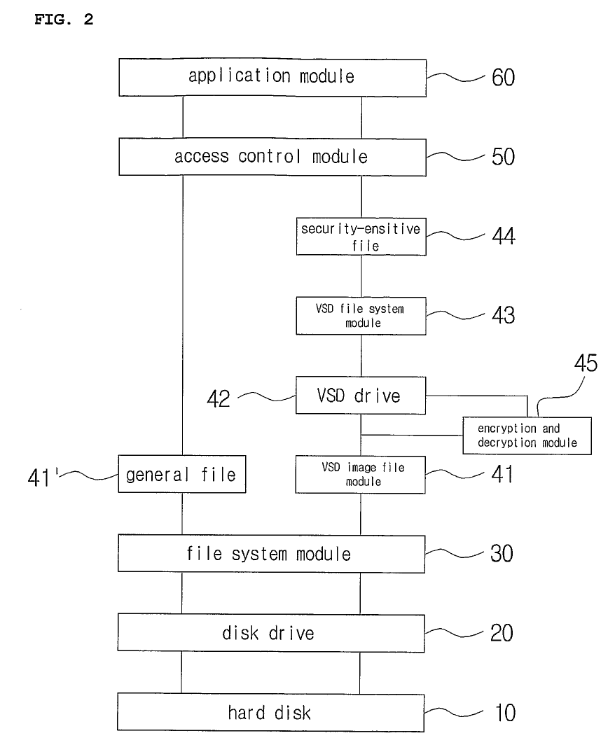

In order to perform the above-described function, the present invention is constructed as described below, and is described in more detail with reference to FIG. 2.

The access control system according to the present invention has a structure including a hard disk 10, a disk drive 20, a file system module 30, an application module 60, a VSD image file module 41, a VSD drive 42, an encryption and decryption module 45, a VSD file system module 43, and an access control module 44.

The hard disk 10 basically stores data necessary to operate a PC or LAN, and the data are managed in file forms by Read, Delete and Edit operations using an OS.

The disk drive 20 includes disk volumes formatted to be compatible with the OS that manages the hard disk 20.

When the hard disk 10 is physically partitioned, a disk volume is assigned to each partitioned area. As a result, the OS manages the hard disk 10 while recognizing a single hard disk 10 as a plurality of disk drives.

The file system module 30 abstracts the physical characteristics of the hard disk 10, arranges the abstracted physical characteristics on a logical storage unit basis, and maps the arranged physical characteristics, thus allowing the OS to process the data on a file basis. Generally, the file system module 30 is installed to support the processing of the OS when the disk volume is recognized by the OS.

The application module 60 is a general application program that is configured to fetch and execute files. In the present invention, the processing of the security-sensitive files is performed differently for the authorized application module A authorized to access the security-sensitive files and the unauthorized application module A′ not authorized to access the security-sensitive files.

The authorization setting of the application module 60 is performed to fetch information (program names, headers, check sums and certificates of authentication) for identifying the types of the application modules and then define identification rules. The access control module 50 operates according to the identification rules.

The VSD image file module 41 is created in a file form within the disk volume formatted by the file system module 30.

The VSD drive 42 is the drive of the VSD image file module 41, which corresponds to the disk drive 20. That is, although the VSD image file module 41 is actually formed based on the concept of a file identical to that of a general file 41′, it may be recognized as a general file or a single disk volume by the OS according to whether the application module that attempts access to a corresponding file has been authorized. The VSD drive 42 is recognized as a disk drive different from the disk drive 20 when the authorized application module A accesses the VSD image file module 41.

The VSD file system module 43 is set up such that the OS can recognize the VSD file system module 43 as a new disk volume at the time of the generation of the VSD image file module 41 and the VSD drive 42 and perform processing at the time of access to a file within the VSD image file module 41 using the authorized application module A.

The VSD file system module 43 corresponds to the file system module 30.

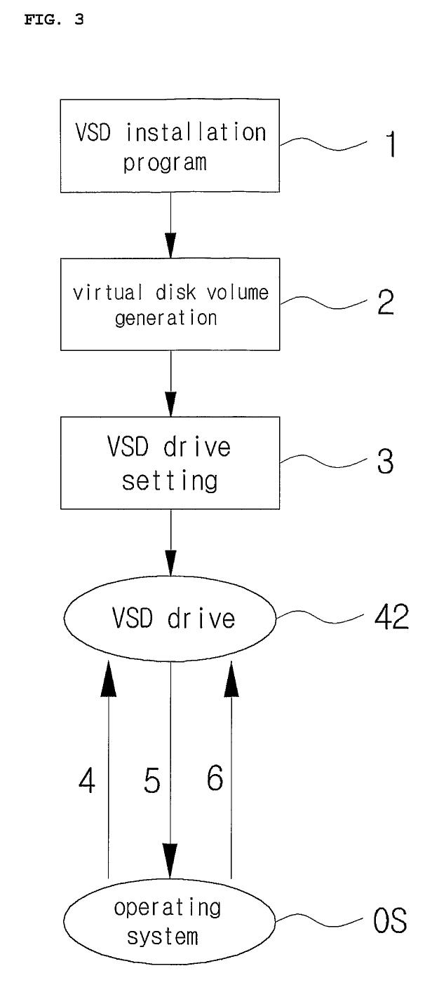

FIG. 3 is a block diagram illustrating a process of setting up the virtual disk of the access control system according to the present invention. The following description is made with reference to the drawing.

A VSD installation program is installed on a corresponding PC or a client PC on a LAN (1), a virtual disk volume is created while occupying a region in a certain space of the disk volume in a file form by a virtual disk volume generation means (not shown) of the VSD installation program (2), and the VSD drive 42, that is, a means for executing the virtual disk volume, is set up by a VSD drive setting means (not shown) (3).

When the VSD drive 42 is set up, the OS requests information (DISK_GEOMETRY information and partition information) about a corresponding virtual disk volume (4), and the VSD drive 42 generates virtual disk volume information that is previously received and then transfers the generated information to the OS in response to the request (5). Furthermore, the OS receives the information, and sets up and formats the VSD file system module 43 in conformity with a range of the concerned information, and recognizes the new disk volume (6).

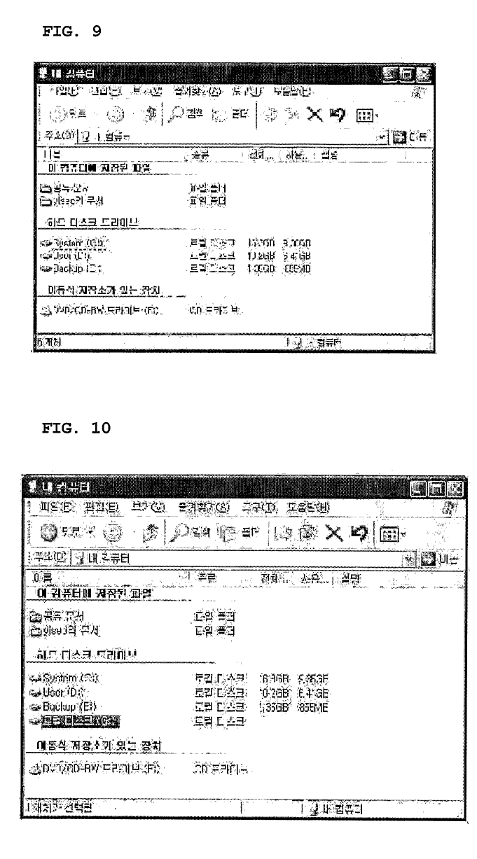

FIG. 9 is my computer window showing the state before the access control system according to the present invention is installed, and FIG. 10 is my computer window showing the state after the access control system according to the present invention has been installed.

The OS recognizes a new hard disk drive as having been created by the VSD image file module 41 and the VSD drive 42.

The encryption and decryption module 45 is a module for encrypting and decrypting input/output data between the VSD image file module 41 and the VSD drive 42. If the input/output data are stored in the VSD image file module 41 without change, information about security-sensitive files may be leaked out by processing the VSD image file module 41 in the same format as the corresponding file system module 30 using an abnormal method, such as hacking. In the access control system according to the present invention, when the security-sensitive files are stored in the VSD image file module, only the location cannot be determined by the unauthorized application module A′, but the information is stored on the hard disk 10 without change. Accordingly, it is preferred that corresponding information be encrypted so as to prevent interpretation even though the security-sensitive files stored on the VSD image file module 41 may be leaked out by an abnormal method.

The encryption of the access control system of the present invention is performed in such a way as to encrypt data to write on a sector basis and record it in the VSD image file module 41 when a WRITE command from the VSD file system module 43 is transferred to the VSD drive 42, and to decrypt data, which are read from the VSD image file module 41, on a sector basis and then transfer the decrypted data to the VSD file system module 43 when a READ command is transferred.

The present invention adopts a symmetric key encryption/decryption method, specifically, the block scheme of the symmetric key method. Such a block scheme performs encryption/decryption after blocking data on the sector (512 bytes) basis of a disk.

Meanwhile, the above-mentioned terms are defined as below. The term security-sensitive file 44 is a file stored to the VSD image file module 41 for security reasons, and the term virtual disk refers to both the VSD image file module 41 and the VSD drive 42.

Next, when the application module 60 attempts to access the VSD image file module 41, the access control module 50 determines access by determining whether a space at which a corresponding task is to be processed is the disk drive 20 or the VSD drive 42, and determining whether the application module 60 has been authorized to access a corresponding file. That is, if it is determined that the application module 60 has been authorized, only Read can be performed on a corresponding file in the case in which the task space is the general disk ND, and both Read and Write can be performed on a corresponding file in the case in which the task space is the VSD drive 42, that is, the virtual disk VD, as described with reference to FIG. 1. In contrast, if it is determined that the application module 60 has not been authorized, Read and Write can be performed on a corresponding file in the case in which the task space is the disk drive 20 and Read and Write cannot be performed on a corresponding file in the case in which the task space is the VSD drive 42.

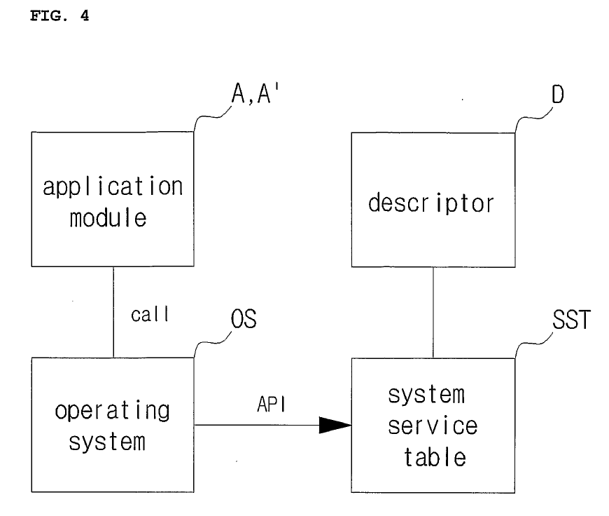

As shown in FIG. 4 (a block diagram illustrating the operation of a conventional system service table), when an application module A or A′ calls a required function from an OS to access a file that is required for execution, the OS provides the corresponding function to a system service table SST and allows it to be pointed at through a descriptor. Accordingly, the application modules A and A′ are implemented to be compatible with each other under the OS.

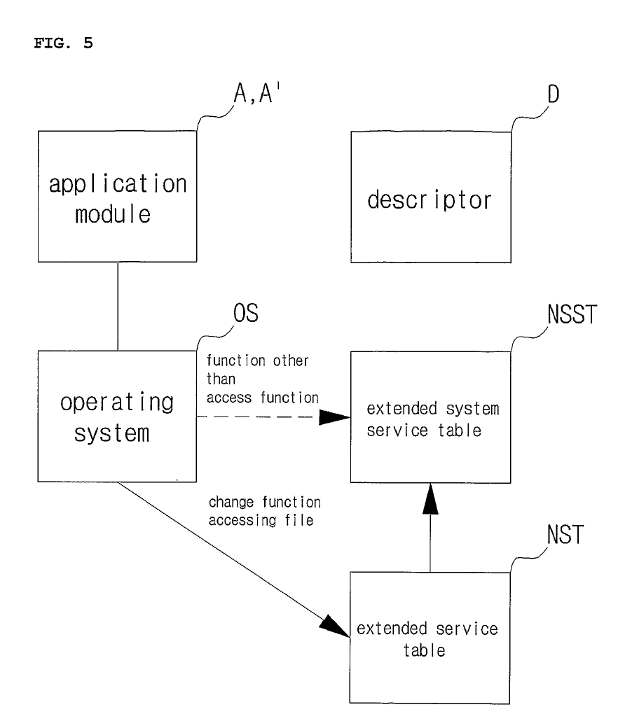

Meanwhile, in the access control system according to the present invention, as shown in FIG. 5 (a block diagram illustrating the operation of a system service table applied to the access control system according to the present invention), the existing system service table SST is replaced by an extended system service table NSST, an extended service table NST is further included, and a process shown in FIG. 6 (an example showing a process in which whether access to a corresponding file by an application program (an application module) has been authorized is processed according to the construction of FIG. 5) is performed.

When the application module A or A′ calls a required function to access a file required for execution, the OS provides the corresponding function to the extended service table NST so that the following operation can be performed.

First, when the application module A or A′ calls a function regarding CreateFile( ), the OS provides ZwCreateFile( ) to the extended service table NST through NtCreateFile( )(ntdll.dll). In this case, the extended service table NST changes ZwCreatFile( ) into OnZwCreateFile( ) (function set to prevent the performance of a corresponding function in the present invention), and then determines whether the operation of the corresponding function is performed in the extended system service table NSST through logic.

In an embodiment according to the present invention, the function OnZwCreateFile( ) prevents the descriptor from performing pointing as ZwCreateFile( ) is immediately provided to the extended system service table NSST when the corresponding function CreateFile( ) is requested. Until the logic is completed, the function ZwCreateFile( ) is maintained in the form of the function OnZwCreateFile( ) and the function CreateFile( ) that is requested by the application module A or A′ is not provided.

In this case, the arbitrarily created function OnZwcreatefile( ) is a function that is formed by changing/replacing the function ZwCreateFile( ) that has previously existed in the conventional system service table SST as the extended service table NST is further installed in the present invention.

Meanwhile, the logic is a determination whether the object file of the called function has been located on the virtual disk VD or the general disk ND, and the application module A or A′, which call the function, has been authorized. That is, if it is determined that the object file has been located on the virtual disk VD, it is determined whether the application module has been authorized. If the application module has been authorized, the unchanged function ZwCreateFile( ) is provided to the extended system service table NSST. Otherwise (False) the operation of the corresponding function is stopped. Furthermore, if it is determined that the object file has been located on the general disk ND, a determination whether the application module has been authorized is omitted, and the unchanged function ZwCreateFile( ) is provided to the extended system service table NSST.

Meanwhile, the descriptor D is pointed at the extended system service table NSST, not the system service table SST.

In FIG. 5, a dashed dot arrow connecting the system service table SST and the extended system service table NSST shows another type of function call, which is required for the implementation of the application modules A and A′, other than the functions actually involved in the file access, and the operation of the function is performed by immediately providing the corresponding function to the extended system service table NSST without processing logic in the extended service table NST.

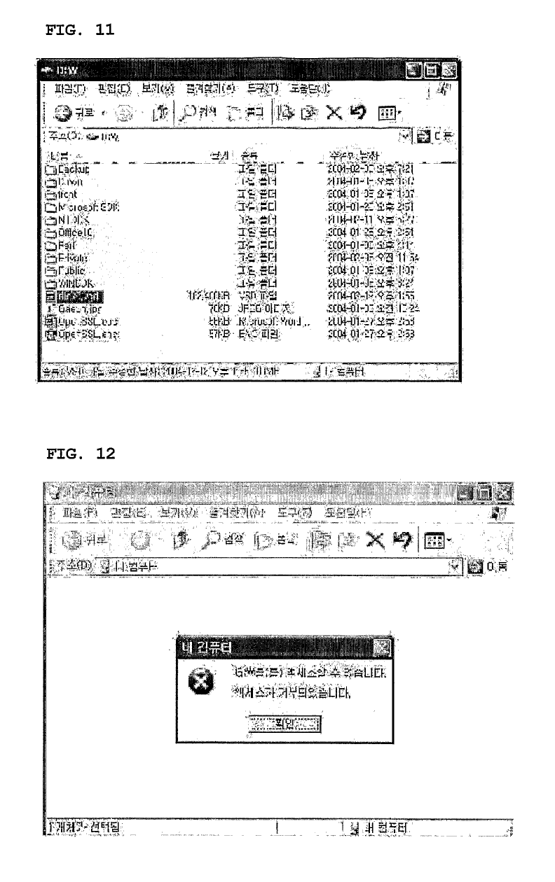

Meanwhile, as described above, access to the security-sensitive file by a function is not permitted for modules except for the authorized application module A. Accordingly, at the time of the unauthorized application module A′ attempting access, it is impossible to access the virtual disk VD according to the present invention from the beginning because the drive itself is not recognized, shown in FIG. 9. Furthermore, as shown in FIG. 11 (an window showing a state in which the virtual disk VD of the access control system according to the present invention is recognized as a file), it is also impossible to access the virtual disk VD using the unauthorized application module because the VSD image file module 41 exists in the form of a file that cannot be opened.

FIG. 12 is a window showing that an access attempt by an unauthorized application module is refused at the time of access to the virtual disk VD, which shows that access is refused when the opening of the VSD image file module 41, which exists in a file form, is attempted on the unauthorized application module A′ or OS.

Meanwhile, when the VSD image file module 41, which occupies a 10 GB space on the hard disk whose total capacity is 40 GB, is regularly installed, a 9 GB is bound to the VSD image file module 41 even though a security-sensitive file having a size of 1 GigaByte (GB) is stored on the VSD image file module 41, so that a general file larger than 30 GB cannot be stored. Accordingly, in another embodiment according to the present invention, the use capacity of the VSD image file module 41 can be flexibly varied.

For this purpose, the present invention employs a sparse file that is utilized on an NT File System (NTFS) basis.

The sparse file allows the OS to recognize that a corresponding space has been occupied by data without occupying all bytes corresponding to the capacity of the large file in a disk space when the need for arbitrarily creating a vast file arises.

That is, in the case of creating a large file of 42 GB, data are written only in a space of 64 kilobytes (KB), which is the start portion of a file, and a space of 64 KB, which is the end portion of the file, without assigning all 42 GB disk space. The NTFS allocates a physical disk space to a file portion to which a user writes data, through which the sparse file uses only a space of 128 KB on the disk. However, from another aspect, it operates like a file of 42 GB in the OS.

When a 1 GB security-sensitive file is stored on a 40 GB hard disk after the VSD image file module 41 having 40 GB has been installed thereon, the OS recognizes the capacity of the VSD image file module 41 as 10 GB. However, when a general file is stored on a general hard disk, the general file larger than 30 GB can be stored thereon, so that the efficiency of space use within the disk is achieved.

The construction of the access control system according to the present invention has been described above, and a access control method using the construction is described below.

Functions ReadFile( ) and WriteFile( ), which are described below, are functions called when the function CreateFile( ) is switched to a read mode or a write mode and executed. The above functions are separately described according to each mode so methods of controlling Read and Write and from and to a security-sensitive file are clearly distinguished from each other under the access control system according to the present invention.

For reference, CreateFile( ), which is a file handler, is first called to access an arbitrary file through the application module, and Read or Write modes are performed while ZwCreateFile( ), which is provided by calling CreateFile( ), calls ReadFile( ) or WriteFile( ), thus performing Read and Write and from and to the corresponding file in the application module.

The step (1) of selectively authorizing the application modules:

The step of designating and authorizing the application module 60 that can access the virtual disk VD. Since the embodiment of the method of authorizing the application module 60 has been described, a description thereof is omitted.

The step (2) of the application module 60 calling a function to access the corresponding module:

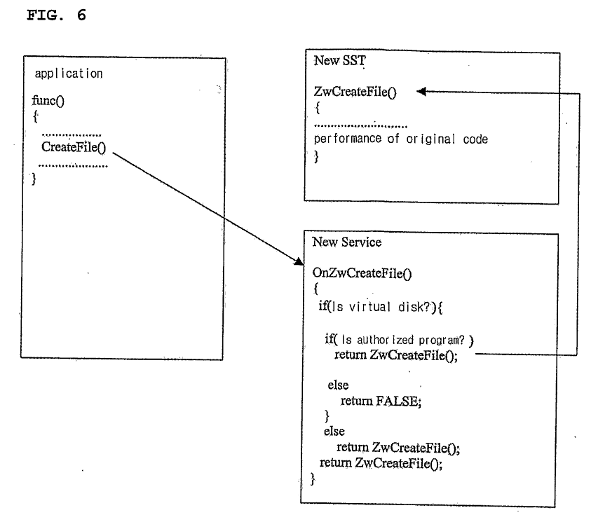

The step (2) corresponds to a start portion of FIG. 7 (flowchart illustrating a process of reading a file using the application program in the access control system according to the present invention), and is the step of the application module 60 requesting Read of the file and calling the function ReadFile( ) for this purpose.

The step (3) of changing the function and entering a standby state:

When the step 2 is performed, the function is provided to the extended service table NST that is included in the access control module 50, and the extended service table NST changes the function ReadFile( ) into OnZwReadFile( ) and performs the logic.

The step (4) of determining whether an access space to the file is the disk drive or the VSD drive:

The step (4) is the step of determining whether the file is located on the virtual disk VD and corresponds to the step S1 of FIG. 7.

The step (5) of restoring the function, which is changed so that the operation thereof is impossible, to the original function and providing the restored function if the space is determined to be the disk drive:

If it is determined that the space in which the file is located is the disk drive 30, the extended service table NST provides ZwReadFile( ), which is a function before being changed into the function OnZwReadFile( ), to the extended system service table NSST and continues the operation of the function. As a result, the Read operation of the corresponding file is permitted at step S4.

The step (6) of determining whether the access of the application module has been authorized if the access space is determined to be the VSD drive at step 4:

If the access space is determined to be the VSD drive 42, it is determined whether the application module 60 has been authorized using the following logic at step S2.

The step (7) of restoring the function, which is changed so that the operation thereof is impossible, to the original function if it is determined that the application module 60 has been authorized at step 6:

If the application module 60 is determined to be the authorized module, the extended service table NST provides ZwReadFile( ), which is a function before being changed into the function OnZwReadFile( ), to the extended system service table NSST and continues the operation of the function. As a result, the Read operation of the corresponding file is permitted at step S4.

The step (8) of stopping the operation of the corresponding function if it is determined that the application module 60 has been unauthorized:

In contrast, if it is determined that the application module 60 has not been authorized, the operation of the corresponding function in the extended system service table NSST is stopped, and the Read operation is not permitted at step 3.

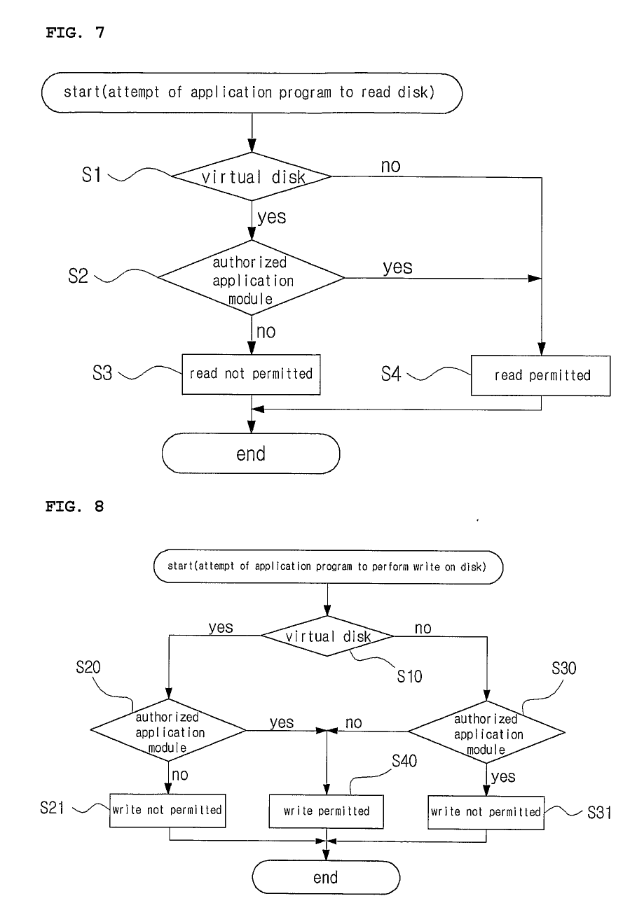

Next, if the function is WriteFile( ), the step 5 further includes the following steps. The steps are described with reference to FIG. 8 (flowchart illustrating a process of performing Write on a corresponding file using an application program in the access control system according to the present invention). In this case, the function WriteFile( ) is changed into OnZwWriteFile( ) in the extended service table NST.

The step (5-1) of determining whether the application module has been authorized;

In the state in which the access space is determined to be the disk drive 20, it is determined whether the application module 60 calling the corresponding function is the authorized application module at step S30.

The step (5-2) of stopping the operation of the corresponding function if the application module has been authorized at step (5-2):

If it is determined that the application module has been authorized at step (5-1), the operation of the corresponding function in the extended system service table NSST is stopped and the Write operation is not permitted at step 31.

The step (5-3) of restoring the function, which is changed so that the operation thereof is impossible, to the original function and providing the restored function if it is determined that the application module has not be authorized at step (5-2):

If it is determined that the application module has not been authorized at step (5-1), the extend service table NST recovers ZwWeadFile( ), which is a function before being changed into the function OnZwWeadFile( ), and provides the recovered function to the extended system service table NSST, and the descriptor D perform pointing, so that Write is permitted through the operation of the corresponding function at step S40.

Since the reason why the steps of the method of controlling the Write function must be further included in the method of controlling the Read function has been described in detail above, a description thereof is omitted below.

Meanwhile, as described above, since the VSD image file module 41 is located on the existing disk volume in a file form, so that only the VSD image file module 41 can be copied and clipped and, then, access is gained and leakage is performed using the existing file system module 30. Accordingly, the step of encrypting and decrypting data input/output between the VSD image file module 41 and the VSD drive 42 must be further included.

### INDUSTRIAL APPLICABILITY

A separate virtual disk VD is created in a system managed by the current OS without the need to physically partition the existing hard disk and is managed as a new drive using a separate file system, and access is permitted only to the authorized application program (application module) at the time of access to a security-sensitive file stored on the drive. Accordingly, PCs, in which the application module (application module) is installed, can easily access security-sensitive files without individually checking internally authorized persons, and only an authorized application program (application module) can access the security-sensitive files. As a result, the security-sensitive files cannot be leaked out to the outside through copy or clip, and illegal access from the outside can be blocked from the beginning.

Furthermore, since the security-sensitive files are separately stored and protected on the virtual disk VD even though tasks for encryption or the granting of the authority to use are not performed, a task required for file security is made easy.

Furthermore, the space use of the hard disk, on which general files file and security-sensitive files have been stored, can be flexibly performed by providing variability to the capacity of the virtual disk VD.

Furthermore, since the consumption of the time that is required to designate all the range of the hard disk corresponding to determined capacity to create a disk volume for the determined capacity in the case in which a large-size virtual disk VD is installed can be avoided, the initial time required for the installation of the virtual disk VD can be considerably reduced.

1. An access control system, comprising:
a Virtual Secure Disk (VSD) image file module occupying a certain space of a hard disk in a file form;
a VSD drive for processing security-sensitive files within the VSD image file module;
an encryption and decryption module for encrypting and decrypting data input/output between the VSD image file module and the VSD drive;
a VSD file system module for allowing an operating system to recognize the VSD drive as a separate disk volume at a time of access to the security-sensitive files within the VSD image file module; and
an access control module for determining access by determining whether an access location is a disk drive or the VSD drive and the application module has been authorized to access a certain file at a time of access to the file, which is stored on the hard disk, to perform tasks in the application module.

2. The access control system according to claim 1, wherein the access control module comprises:
an extended system service table for allowing the operation of a corresponding function to be performed when it is pointed at by a descriptor; and
an extended system table for changing a function, which is requested of the service system table by the application module, to prevent operation of the function, determining whether a space in which a corresponding task is performed is the disk drive or the VSD drive, determining whether access to the corresponding file by the application module has been authorized, and providing the unchanged function to the extended system service table or stopping the operation of the function according to results of the determination.

3. The access control system according to claim 1 or 2, wherein the VSD image file module virtually occupies the hard disk so as to allow the operating system to recognize the data as being assigned to a certain space of the hard disk without performing physical assignment for storing the data on the hard disk, so that the authorized application module can physically assign the data to the space.

4. An access control method, which is performed by an access control system having a hard disk, a disk drive, a file system module, an application module, a VSD image file module, a VSD drive, an encrypting/decrypting module, a VSD file system module, and a control access module including an extended system service table and an extended service table, comprising the steps of:
(a) authorizing the application modules;
(b) the application module calling a function from an operating system to access a corresponding file;
(c) the operating system providing the function to the extended service table;
(d) changing the function into an arbitrarily designated function to prevent the operation of the function in the extended service table;
(e) determining whether the access space of the file is the disk drive or the VSD drive in the extended service table;
(f) returning the arbitrarily designated function to the original function whose operation is possible, and providing the original file to the extended system service table if it is determined that the access space is the disk drive at step (e);
(g) determining whether access to the application module has been authorized if it is determined that the access space is the disk drive at step (e);
(h) returning the arbitrarily designated function to the original function whose operation is possible, and providing the original function to the extended system service table if it is determined that the application module has been authorized at step (g); and
(i) stopping the operation of the corresponding function if it is determined that the application module has not been authorized at step (g).

5. The application-based access control method according to claim 4, wherein, if the function is a function requesting a Write operation, the step (e) comprises the steps of:
determining whether the application module has been authorized;
stopping the operation of the function if it is determined the application module has been authorized; and
the arbitrarily designated function returning to the original function, the operation of which is possible, and being provided to the extended system service table if it is determined that the application module has been unauthorized.

6. The access control method according to claim 4 or 5, further comprising the step of the encryption and decryption module encrypting and decrypting data that are input and output between the VSD image file module and the VSD drive.
